(19) United States
(12) Patent Application Publication
(10) Pub. No.: US 2020/0238617 A1
(43) Pub. Date: Jul. 30, 2020

(54) APPARATUSES WITH A POROUS MEMBRANE TO FLUIDIZE PARTICULATE MATERIAL

(71) Applicant: HEWLETT-PACKARD DEVELOPMENT COMPANY, L.P., Spring, TX (US)

(72) Inventors: Terry Lambright, Corvallis, OR (US); David R. Otis, JR., Corvallis, OR (US); Kelly B. Smith, Corvallis, OR (US)

(21) Appl. No.: 16/608,912

(22) PCT Filed: Oct. 20, 2017
(86) PCT No.: PCT/US2017/057721

§ 371 Date: Oct. 28, 2019

(51) Int. Cl. B29C 64/255; B33Y 30/00; B01F 13/02; B29C 64/153; B22F 3/105

(52) U.S. Cl. CPC B29C 64/255; B33Y 30/00; B22F 2003/1056; B29C 64/153; B22F 3/1055; B01F 13/0266

(57) ABSTRACT

According to examples, an apparatus may include a hopper having side walls, a bed positioned within the side walls, and a porous membrane supported above the bed. The porous membrane may have a plurality of pores having sizes that are between about 5 microns and about 15 microns and having a density of about 10 and about 30 percent of a material forming the porous membrane. A space between the bed and the porous membrane is to be pressurized with a gas and the gas is to flow through the porous membrane to fluidize particulate material provided on the porous membrane. The apparatus may also include a drain opening extending through the porous membrane and a drain aperture extending through the bed.

### BACKGROUND

In three-dimensional (3D) printing, an additive printing process is often used to make three-dimensional solid parts from a digital model. 3D printing is often used in rapid product prototyping, mold generation, mold master generation, and manufacturing. Some 3D printing techniques are considered additive processes because they involve the application of successive layers of particulate material to an existing surface (template or previous layer). Additive processes often include solidification of the particulate material, which for some materials may be accomplished through use of heat and/or chemical binders.

### BRIEF DESCRIPTION OF THE DRAWINGS

Features of the present disclosure are illustrated by way of example and not limited in the following figure(s), in which like numerals indicate like elements, in which:

FIG. 1 shows a perspective view an example apparatus that includes components to fluidize a particulate material;

FIG. 2 shows an example open cell foam of which the porous membrane depicted in FIG. 1 may be formed;

FIG. 3 shows a schematic diagram of another example apparatus;

FIG. 4 shows a perspective, exploded view of an example fluidizing assembly; and

FIG. 5 shows a block diagram of an example 3D printing system in which the apparatuses and fluidizing assemblies disclosed herein may be implemented.

### DETAILED DESCRIPTION

Disclosed herein are apparatuses that include fluidizing assemblies to fluidize particulate material. The apparatuses may include a hopper, within which a porous membrane may be provided. The porous membrane may be spaced from a bed and gas may be supplied into the space such that space becomes pressurized and the gas permeates through the porous membrane. The gas may permeate through the porous membrane at sufficient velocities and volumes to fluidize particulate material contained in the hopper. That is, the gas may fluidize a portion or all of the particulate material contained in the hopper. In addition, the fluidized particulate material may flow through a drain opening in the porous membrane to a controllable feeder, which may control expulsion of the particulate material from the hopper.

The particulate material may include build material particles used in the formation of 3D printed objects. According to examples, the porous membrane may be designed for fluidizing such particulate materials. For instance, the porous membrane may include pores having sizes that range from about 5 microns to about 20 microns. In addition, the pores of the porous membrane may constitute about 10 and about 50 percent of the material forming the porous membrane. The porous membrane may also be formed of ultra high molecular weight polyethylene.

Before continuing, it is noted that as used herein, the terms “includes” and “including” mean, but is not limited to, “includes” or “including” and “includes at least” or “including at least.” The term “based on” means “based on” and “based at least in part on.”

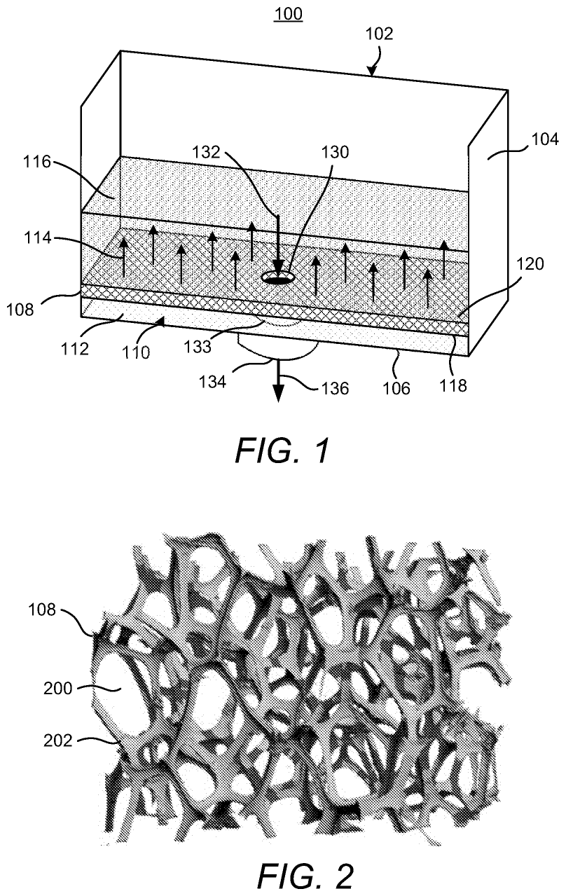

With reference first to FIG. 1, there is shown a perspective view of an example apparatus 100 that includes components to fluidize a particulate material. The components to fluidize a particulate material may also be referenced herein as a fluidizing assembly. It should be understood that the apparatus 100 depicted in FIG. 1 may include additional components and that some of the components described herein may be removed and/or modified without departing from a scope of the apparatus 100 disclosed herein.

As shown in FIG. 1, the apparatus 100 may include a hopper 102 (which may equivalently be termed a container) having sidewalls 104 and a bed 106 positioned within the side walls 104. One of the walls 104 has been removed to better illustrate the interior of the hopper 102. The apparatus 100 may also include a porous membrane 108 supported above the bed 106 such that a space 110 may exist between the bed 106 and the porous membrane 108. The bed 106 may be a floor of the hopper 102 or may be a component that rests on a floor of the hopper 102. As discussed herein, the space 110 may be pressurized with a gas 112 and the gas 112 may flow through the porous membrane 108 as indicated by the arrows 114. In addition, the gas 112 may permeate into particulate material 116 that is supported on the porous membrane 108.

In examples, a gas pressure generator (not shown) may supply the gas 112 into the space 110 through a gas delivery opening (not shown) in the bed 106 with sufficient pressurization to cause the gas 112 to flow through the porous membrane 108 with sufficient velocity and pressure to fluidize the particulate material 116. That is, the gas 112 may be supplied at sufficient velocities through the particulate material 116 to cause the particulate material 116 to acquire characteristics of a fluid, which may mix the particulate material 116 and may facilitate movement of the particulate material 116. Fluidization of the particulate material 116 may help with the outflow of the particulate material 116 from the hopper 102 by enabling the particulate material 116 to flow better and to self-level. In addition, fluidization of the particulate material 116 may minimize the volume of stranded particulate material 116 in the hopper 102, which may facilitate emptying of the hopper 102.

According to examples, the particulate material 116 may be build material particles used to form 3D objects through a 3D printing operation. For instance, the particulate material 116 may be formed of any suitable material including, but not limited to, polymers, plastics, metals, and ceramics and may be in the form of a powder or a powder-like material. Additionally, the particulate material 116 may be formed to have dimensions, e.g., widths, diameters, or the like, that are generally between about 5 μm and about 100 μm. In other examples, the particulate material 116 may have dimensions that are generally between about 30 μm and about 60 μm. The particulate material 116 may have any of multiple shapes, for instance, as a result of larger particles being ground into smaller particles. In addition, the particulate material 116 may be fresh powder (e.g., unused build material particles), used powder (e.g., recycled build material particles), or a combination of fresh and used powder. In some examples, the powder may be formed from, or may include, short fibers that may, for example, have been cut into short lengths from long strands or threads of material.

The porous membrane 108 may extend across opposite side walls 104 to prevent the particulate material 116 from falling between the porous membrane 108 and the sidewalls 104 and into the space 110. In addition, the porous membrane 108 may be formed of a material and may have a suitable thickness to support the particulate material 116. For instance, the porous membrane 108 may be formed of polyethylene, metal, plastic, combinations thereof, or the like. By way of particular example, the porous membrane is formed of ultra high molecular weight polyethylene (UHMWPE). The thickness of the porous membrane 108 may be selected based upon the type and/or the amount of particulate material 116 that the hopper 102 is to house.

The porous membrane 108 may have a plurality of pores (which are equivalently termed channels herein), that enable the gas 112 to flow from a first side 118 of the porous membrane 108 facing the bed 106 to a second side 120 of the porous membrane 108 that faces away from the bed 106. The pores (channels) may follow tortuous or equivalently, circuitous, paths from the first side 118 to the second side 120 of the porous membrane 108. That is, for instance, the pores may not follow a direct vertical path from the first side 118 to the second side 120 of the porous membrane 108. In some examples, the porous membrane 108 may be formed by bonding beads of material together with an adhesive or through partially melting of the beads, which may have spherical shapes. As another example, the porous membrane 108 may be formed of an open cell foam as shown in FIG. 2. That is, the porous membrane 108 may include a plurality of pores 200 formed between a material forming a mesh or interlaced structure.

According to examples, the pores 200 may have sizes that are sufficiently small to thus prevent the particulate material 116 from entering and/or blocking the pores 200. The flow of the gas 112 through the pores 200 may also remove particulate material 116 from the pores 200. In addition or in other examples, the pores 200 may have sizes that are between about 5 microns and about 20 microns and include a density of about 10 and about 50 percent of a material forming the porous membrane 108. In other examples, the pores 200 may have sizes that are about 10 microns and may include a density of about 30 percent of the material forming the porous membrane 108. For instance, the pores 200 may have sizes that are between and including 9 microns and 11 microns and may include a density of between and including 29 and 31 percent of the material forming the porous membrane 108. In still other examples, the pores 200 may have sizes that are 10 microns and/or may include a density of 30 percent of the material forming the porous membrane 108.

With reference back to FIG. 1, the porous membrane 108 may include a drain opening 130. In some examples, the drain opening 130 may include a cutout portion of the porous membrane 108. In addition or in other examples, the drain opening 130 may include a drain member around a cutout portion, in which the drain member may be a metal or plastic member that defines the drain opening 130. In any regard, the particulate material 116 may flow through the drain opening 130 (as represented by the arrow 132) to be delivered out of the hopper 102. That is, some of the particulate material 116 may flow through the drain opening 130, through a drain aperture 133 formed in the bed 106, and into a controllable feeder 134. The controllable feeder 134 may control the expulsion of the particulate material 116 from the hopper 102 as indicated by the arrow 136. The controllable feeder 134 may be positioned beneath the bed 106 and particulate material 116 that has flowed through the drain opening 130 and the drain aperture 133 may be supplied into the controllable feeder 134 and the controllable feeder 134 may control the expulsion of the particulate material 116 (as represented by the arrow 136).

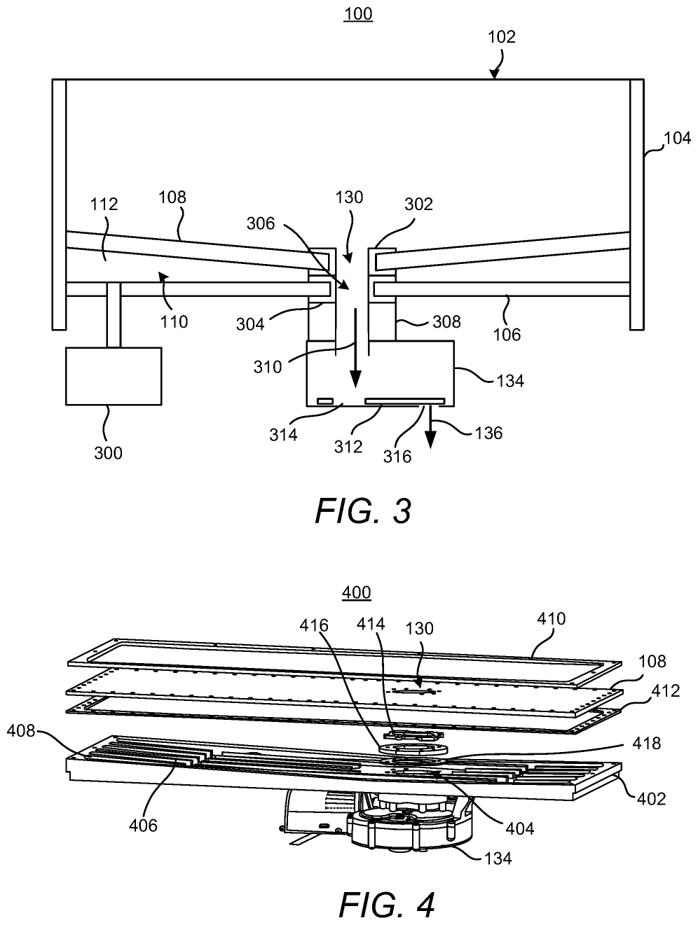

Turning now to FIG. 3, there is shown a schematic diagram of the apparatus 100 depicted in FIG. 1 according to another example. The apparatus 100 is depicted in FIG. 3 as including a hopper 102, side walls 104, a bed 106, a porous membrane 108, a space 110 between the bed 106 and the porous membrane 108, and a drain opening 130 in the porous membrane 108. However, in FIG. 3, the porous membrane 108 is depicted as being sloped from the drain opening 130 to a periphery of the porous membrane 108. In this regard, for instance, the peripheral sections of the porous membrane 108 that may be attached to the side walls 104 may be elevated as compared with the drain opening 130. Particulate material 116 contained in the hopper 102 may thus gravitate more readily toward the drain opening 130.

Also shown in FIG. 3 is a gas pressure generator 300 that may generate and supply gas 112 flow into the space 110. The gas pressure generator 300 may be a pump, a fan, a blower, or the like. The gas 112 may be air or another type of gas that may be supplied to condition the particulate material 116. For instance, the gas 112 may be an inert gas, such as nitrogen, which may reduce or prevent oxidation of the particulate material 116 as compared with oxygen. In some examples, the apparatus 100 may include a temperature manipulating device (not shown) to vary the temperature of the gas 112 supplied into the space 110. The temperature manipulating device may be a heater, a chiller, ora combination thereof. In some examples, the apparatus 100 may include a moisture controlling device (not shown) to vary the moisture content of the gas 112. The moisture controlling device may be a humidifier, a dehumidifier, or a combination thereof.

The apparatus 100 may also include a drain member including a first gasket 302 provided in the drain opening 130 of the porous membrane 108 and a second gasket 304 provided in a drain aperture 306 of the bed 106. The first gasket 302 and the second gasket 304 may include respective mating elements (not shown) to connect the first gasket 302 and the second gasket 304 to each other. Thus, for instance, the connection between the first gasket 302 and the second gasket 304 may maintain the porous member 108 in the sloped (or equivalently, angled) arrangement shown in FIG. 3.

As shown, the drain opening 130 and the drain aperture 306 may be aligned with each other such that the particulate material 116 that flows into the drain opening 130 also flows through the drain aperture 306. The particulate material 116 may also flow through a collar 308 that may include an opening that may be aligned with the drain opening 130 and the drain aperture 306. The collar 308 may be attached to the second gasket 304 and in some examples, may be integrated with the second gasket 306. The collar 308 may also be attached to the controllable feeder 134 and in some examples, may be integrated with the controllable feeder 134. In any regard, particulate material 116 may flow through the collar 308 and into the controllable feeder 134 as indicated by the arrow 310.

The controllable feeder 134 may include a rotating member 312 that includes an opening 314 into which the particulate material 116 may flow. In operation, the rotating member 312 may be driven by a motor (not shown) and may rotate about a central axis and as the opening 314 becomes aligned with an outlet opening 316 in the controllable feeder 134, the particulate material 116 in the opening 314 may fall through the outlet opening 316 as indicated by the arrow 136. For instance, the particulate material 116 that is expelled through the outlet opening 316 may be supplied into a conduit (not shown) through which the particulate material 116 may be delivered for usage in the printing of 3D objects and/or in another location of a 3D printer for storage of the particulate material 116 in the other location. According to examples, the rate at which the particulate material 116 is expelled from the hopper 102 may be varied by varying the speed at which the rotating member 312 rotates.

Turning now to FIG. 4, there is shown a perspective, exploded view of an example fluidizing assembly 400. The fluidizing assembly 400 depicted in FIG. 4 includes the porous membrane 108 discussed above, which may include the drain opening 130. The fluidizing assembly 400 may also include a bed 402 that may differ from the bed 106 discussed above with respect to FIGS. 1-3. That is, the bed 402 in the fluidizing assembly 400 may include a curved, sloped, concave, or the like, configuration. Particularly, the bed 402 may include a drain aperture 404 and the section, e.g., the upwardly facing surface, of the bed 402 may be curved such that the peripheral areas of the bed 402 are elevated in comparison with the drain aperture 404. In addition, the bed 402 may be formed to include a plurality of dividers 406 to create pockets of spaces 408 in the bed 402 into which pressurized gas 112 may be delivered. The pockets of spaces 408 may be in fluidic connection with a gas pressure generator 300 via a gas injection opening (not shown) such that the gas pressure generator 300 may pressurize the spaces 408 with a gas 112 for permeation through the porous membrane 108. In this regard, the bed 402 may include one or a plurality of connections through which gas may be delivered into the spaces 408.

The fluidizing assembly 400 may also include a hold down member 410 and a seal gasket 412. The hold down member 410 may be curved in similar fashion to the bed 402. Although not shown, mechanical fasteners may be provided through the hold down member 410, the porous membrane 108, and the seal gasket 412 and may be fastened to the bed 402. In addition, the fluidizing assembly 400 may include a first inner gasket 414, an inner donut 416, and a second inner gasket 418, all of which may be implemented to hold the section of the porous membrane 108 at which the drain opening 130 is located near the drain aperture 404 in the bed 402. In addition, the first inner gasket 414, the inner donut 416, and the second inner gasket 418 may each include aligned holes through which particulate material 116 may flow. In this regard, the porous membrane 108 may have a curved or sloped configuration that may be similar to the curvature of the bed 402. In other examples, the first inner gasket 414, the inner donut 416, and the second inner gasket 418 may be formed as an integrated component.

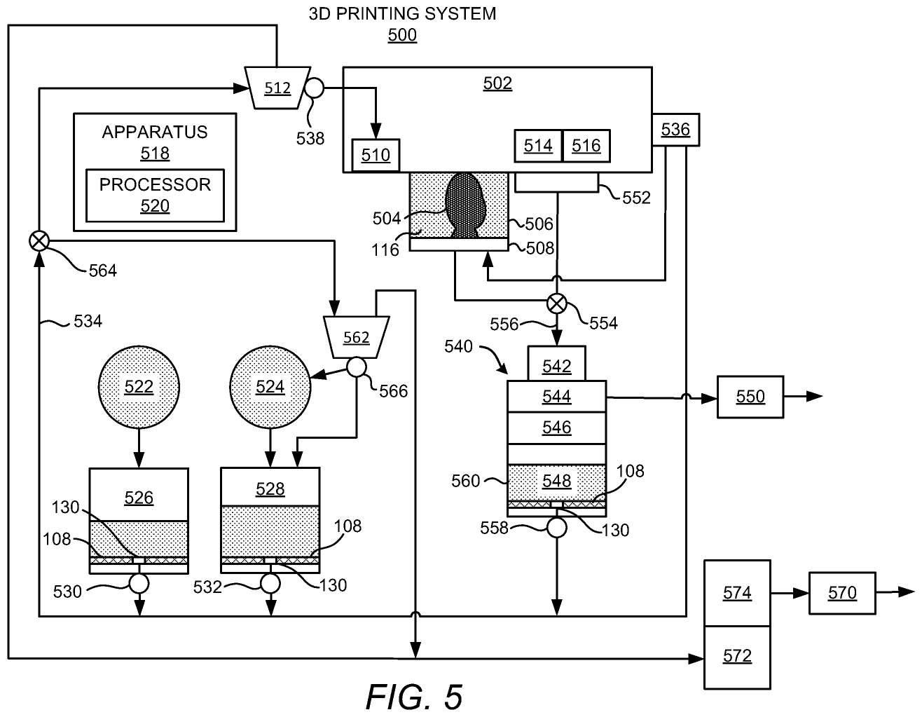

With reference now to FIG. 5, there is shown a block diagram of an example 3D printing system 500 in which the apparatuses 100 and fluidizing assemblies 400 disclosed herein may be implemented. It should be understood that the 3D printing system 500 depicted in FIG. 5 may include additional components and that some of the components described herein may be removed and/or modified without departing from a scope of the 3D printing system 500 disclosed herein. The description of FIG. 5 is made with reference to the elements shown in FIGS. 1-4 for purposes of illustration and not of limitation.

As shown, the 3D printing system 500 may include a build chamber 502 within which a 3D object 504 may be fabricated from particulate material 116, e.g., build material particles, provided in respective layers in a build bucket 506. Particularly, a movable build platform 508 may be provided in the build bucket 506 and may be moved downward as the 3D object 504 is formed in successive layers of the particulate material 116. An upper hopper 512, which may include a cyclone separator, may supply a spreader 510 with the particulate material 116. The spreader 510 may move across the build bucket 506 to form the successive layers of the particulate material 116 received from the upper hopper 512.

Forming components 514 may be implemented to deliver an agent onto selected locations on the layers of particulate material 116 to form sections of the 3D object 504 in the successive layers. The forming components 514 may include an agent delivery device or multiple agent delivery devices, e.g., printheads, fluid delivery devices, etc. Thus, although the forming components 514 have been depicted as a single element, it should be understood that the forming components 514 may represent multiple elements. A heating mechanism 516 to apply heat onto the layers of particulate material 116 to form the sections of the 3D object 504 may also be provided in the build chamber 502.

According to examples, the agent may be a fusing agent that may enhance absorption of heat from the heating mechanism 516 to heat the particulate material 116 to a temperature that is sufficient to cause the particulate material 116 upon which the agent has been deposited to melt. In addition, the heating mechanism 516 may apply heat, e.g., in the form of heat and/or light, at a level that causes the particulate material 116 upon which the agent has been applied to melt without causing the particulate material 116 upon which the agent has not been applied to melt. In other examples, the agent may be a chemical binder that may cause the particulate material 116 upon which the agent is deposited to bind together to form part of a 3D object when the agent solidifies. In these examples, the heating mechanism 516 may be implemented to dry the agent or may be omitted in instances in which the chemical binder binds the particulate material 116 in the absence of additional heat.

The forming components 514 may supply multiple types of agents onto the layers of particulate material 116. The multiple types of agents may include agents having different properties with respect to each other. In this regard, a processor 520 of a computing apparatus 518 may control the forming components 514 to supply the agent or a combination of agents that results in the object 504 having certain features. By way of particular example, the multiple types of agents may be differently colored inks and the processor 520 may control the forming components 514 to deposit an agent or a combination of agents onto particulate material 116 to form an object 504 having a particular color from the particulate material 116.

The processor 520 may control various operations in the 3D printing system 500 including the spreader 510, the hopper 512, and the forming components 514. The processor 520 may implement operations to control the forming components 514 to form the 3D object 504 in a volume of particulate material 116 contained in the build bucket 506.

The particulate material 116 used to form the 3D object 504 may be composed of particulate material from a fresh supply 522 of build material particles, build material particles from a recycled supply 524 of build material particles, or a mixture thereof. The fresh supply 522 may represent a removable container that contains particulate material 116 that has not undergone any 3D object formation cycles. The recycled supply 524 may represent a removable container that contains particulate material 116 that has undergone at least one 3D object formation cycle and may contain particles that have undergone different numbers of 3D object formation cycles with respect to each other.

As shown, the particulate material 116 in the fresh supply 522 may be provided into a fresh material hopper 526 and the particulate material 116 in the recycled supply 524 may be provided into a recycled material hopper 528. Additionally, the particulate material 116 in either or both of the fresh material hopper 526 and the recycled material hopper 528 may be supplied to the upper hopper 512. The particulate material 116 may be provided into the hoppers 526, 528 from the respective supplies 522, 524 prior to implementing a print job to ensure that there are sufficient particulate materials 116 to complete the print job. Either or both of the hoppers 526, 528 may be equivalent to the apparatuses 100 discussed herein. Thus, for instance, the hoppers 526 and/or 528 may include a fluidizing assembly, e.g., a porous membrane 108 having a drain opening 130, to fluidize particulate material 116 contained in the hoppers 526 and/or 528.

Generally speaking, the processor 520 may control the mixture or ratio of the fresh particles and recycled particles that are supplied to the upper hopper 512. The ratio may depend upon the type of 3D object 504 being formed. For instance, a higher fresh particle to recycled particle ratio, e.g., up to a 100 percent fresh particle composition, may be supplied when the 3D object 504 is to have a higher quality, to have thinner sections, have higher tolerance requirements, or the like. Conversely, a lower fresh particle to recycled particle ratio, e.g., up to a 100 percent recycled particle composition, may be supplied when the 3D object 504 is to have a lower quality as may occur when the 3D object 504 is a test piece or a non-production piece, when the 3D object 504 is to have lower tolerance requirements, or the like. The ratio may be user-defined, may be based upon a particular print job, may be based upon a print setting of the 3D printing system 500, and/or the like.

In any regard, the processor 520 may control the ratio of the fresh and the recycled particles supplied to the upper hopper 512 through control of respective feeders 530, 532. The feeders 530, 532 may be equivalent to the controllable feeders 134 discussed herein with respect to FIGS. 1-4. A first feeder 530 may be positioned to supply particulate material 116 to a supply line 534 from the fresh material hopper 526 and the second feeder 532 may be positioned to supply particulate material 116 to the supply line 534 from the recycled material hopper 528. The first feeder 530 and the second feeder 532 may be rotary airlocks that may regulate the flow of the particulate material 116 from the respective hoppers 526, 528 to the feed line 534 for delivery to the upper hopper 512. The feed line 534 may also be supplied with air from an input device 536 to assist in the flow of the particulate materials 116 from the hoppers 526, 528 to the upper hopper 512.

A third feeder 538, which may also be a rotary airlock (which allows forward-flow of powder and restricts back-flow of air), may be positioned along a supply line from the upper hopper 512 to the spreader 510. The upper hopper 512 may include a level sensor (not shown) that may detect the level of particulate material 116 contained in the upper hopper 512. The processor 520 may determine the level of the particulate material 116 contained in the upper hopper 512 from the detected level and may control the feeders 530, 532 to supply additional particulate material 116 in a particular ratio when the processor 520 determines that the particulate material 116 level in the upper hopper 512 is below a threshold level, e.g., to ensure that there is a sufficient amount of particulate material 116 to form a layer of particulate material 116 having a certain thickness during a next spreader 510 pass.

The 3D printing system 500 may also include a collection mechanism 540, which may include a blow box 542, a filter 544, a sieve 546, and a reclaimed material hopper 548. The reclaimed material hopper 548 may be equivalent to the apparatuses 100 discussed herein. Thus, for instance, the reclaimed hopper 548 may include a fluidizing assembly to fluidize particulate material 116, e.g., a porous membrane 108 having a drain opening 130, contained in the reclaimed hopper 548. Airflow through the collection mechanism 540 may be provided by a collection blower 550. The collection mechanism 540 may reclaim incidental particulate material 116 from the build bucket 506 as well as from a location adjacent to the build bucket 506 as shown in FIG. 5. Particularly, following formation of the 3D object 504, the particulate material 116 may remain in powder form and the collection mechanism 540 may reclaim the particulate material 116 that was not formed into the 3D object 504. That is, the incidental particulate material 116 may be separated from the 3D object 504 through application of a vacuum force inside the build bucket 506. The collection mechanism 540 may also be vibrated to separate the incidental particulate material 116 from the 3D object 504.

The incidental particulate material 116 in the build bucket 506 may be sucked into the blow box 542 and through the filter 544 and the sieve 546 before being collected in the reclaimed material hopper 548. Additionally, during spreading of the particulate material 116 to form layers on the build bucket 506, e.g., as the spreader 510 moves across the build bucket 506, excess particulate material 116 may collect around a perimeter of the build bucket 506. As shown, a perimeter vacuum 552 may be provided to collect the excess particulate material 116, such that the collected particulate material 116 may be supplied to the collection mechanism 540. A valve 554, such as an electronically controllable three-way valve, may be provided along a feed line 556 from the build bucket 506 and the perimeter vacuum 552. In examples, the processor 520 may manipulate the valve 554 such that particles flow from the perimeter vacuum 552 during formation of the 3D object 504 and flow from the build bucket 506 following formation of the 3D object 504.

A fourth feeder 558, which may also be a rotary airlock, may be provided to feed the reclaimed particulate material 560 contained in the reclaimed material hopper 548 to the upper hopper 512 and/or to a lower hopper 562. The fourth feeder 558 may feed the reclaimed particulate material 560 through the feed line 534. A valve 564, such as an electronic three-way valve, e.g., the valve 564 may be a three-port, two-state valve in which materials may flow in one of two directions), may be provided along the feed line 534 and may direct the reclaimed particulate material 560 to the upper hopper 512 or may divert the reclaimed particulate material 560 to the lower hopper 562. The processor 520 may also manipulate the valve 564 to control whether the reclaimed particulate material 560 are supplied to the upper hopper 512 or the lower hopper 562. As discussed above, the processor 520 may make this determination based upon the ratio of fresh and recycled particulate materials that is to be used to form the 3D object 504.

A fifth feeder 566, which may also be a rotary airlock, may be provided to feed the reclaimed particulate material 116 contained in the lower hopper 562 to the recycled supply 524 and/or the recycled material hopper 528. The processor 520 may control the fifth feeder 566 to feed the reclaimed particulate material 560 into the recycled supply 524 in instances in which the reclaimed particulate material 560 are not to be used in a current build. In addition, the processor 520 may control the fifth feeder 566 to feed the reclaimed particulate material 560 into the recycled material hopper 528 in instances in which the reclaimed particulate material 560 are to be used in a current or a next build.

The 3D printing system 500 may also include a blower 570 that may create suction to enhance airflow through the lines 534 in the 3D printing system 500. The airflow may flow to a filter box 572 and a filter 574 that may remove particulates from the airflow from the upper hopper 512 and the lower hopper 562 prior to the airflow being exhausted from the 3D printing system 500. In other words, the blower 570, filter box 572, and filter 574 may represent parts of the outlets of the upper hopper 512 and the lower hopper 562 and may collect particulates that were not removed from the airflow in cyclone separators connected to the upper and/or lower hoppers 512 and 562.

Although not shown in FIG. 5, the computing apparatus 518 may also include an interface through which the processor 520 may communicate instructions to a plurality of components contained in the 3D printing system 500. The interface may be any suitable hardware and/or software through which the processor 520 may communicate the instructions. In any regard, the processor 520 may communicate with the components of the 3D printing system 500 as discussed above.

The processor 520 may be a semiconductor-based microprocessor, a central processing unit (CPU), an application specific integrated circuit (ASIC), a field-programmable gate array (FPGA), a graphics processing unit (GPU), a tensor processing unit (TPU), and/or other hardware device. The computing apparatus 518 may also include a memory that may have stored thereon machine readable instructions (which may also be termed computer readable instructions) that the processor 520 may execute. The memory may be an electronic, magnetic, optical, or other physical storage device that contains or stores executable instructions. The memory may be, for example, Random Access memory (RAM), an Electrically Erasable Programmable Read-Only Memory (EEPROM), a storage device, an optical disc, and the like. The memory, which may also be referred to as a computer readable storage medium, may be a non-transitory machine-readable storage medium, where the term “non-transitory” does not encompass transitory propagating signals.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a hopper having side walls;
a bed positioned within the side walls;
a porous membrane supported above the bed, the porous membrane having a plurality of pores having sizes that are between about 5 microns and about 20 microns and comprising a density of about 10 and about 50 percent of a material forming the porous membrane, wherein a space between the bed and the porous membrane is to be pressurized with a gas and the gas is to flow through the porous membrane to fluidize particulate material provided on the porous membrane;
a drain opening extending through the porous membrane; and
a drain aperture extending through the bed.

2. The apparatus according to claim 1, wherein the plurality of pores include tortuous paths from a first side to a second side of the porous membrane.

3. The apparatus according to claim 1, wherein the plurality of pores have sizes that are smaller than widths of particles forming the particulate material.

4. The apparatus according to claim 1, wherein the porous membrane is formed of a material selected from the group consisting of polyethylene, metal, plastic, and combinations thereof.

5. The apparatus according to claim 1, wherein the bed comprises a porous membrane facing section, the section being sloped from the drain aperture to a periphery of the bed.

6. The apparatus according to claim 1, wherein the porous membrane is sloped from the drain opening to a periphery of the porous membrane.

7. The apparatus according to claim 1, further comprising:
a first gasket provided in the drain opening;
a second gasket provided in the drain aperture, wherein the first gasket and the second gasket include respective mating elements to attach the first gasket to the second gasket; and
a controllable feeder positioned beneath the bed to regulate flow of the particulate material through the drain opening and the drain aperture.

8. The apparatus according to claim 1, wherein the plurality of pores have sizes that are about 10 microns and comprise a density of about 30 percent of the material forming the porous membrane.

9. An apparatus comprising:
a bed having a concave surface and a drain aperture positioned at a bottom of the concave surface;
a porous membrane having a plurality of channels having sizes that are between about 5 microns and about 20 microns and comprising a density of about 10 and about 50 percent of a material forming the porous membrane, the porous membrane having a first side, a second side, and a drain opening, wherein the porous membrane comprises a plurality of channels that include circuitous routes from the first side to the second side, and wherein the porous membrane has a curved shape; and
a drain member having a first portion provided on the bed at the drain aperture and a second portion provided on the porous membrane at the drain opening.

10. The apparatus according to claim 9, wherein the plurality of channels have sizes that are about 10 microns and comprise a density of about 30 percent of the material forming the porous membrane.

11. The apparatus according to claim 9, further comprising a seal gasket positioned between peripheries of the bed and the porous membrane and a curved hold down member to hold the porous membrane in contact with the seal gasket.

12. The apparatus according to claim 9, wherein the bed comprises a plurality of dividers to form a plurality of spaces, wherein the porous membrane is positioned atop the plurality of dividers and gas is supplied into the plurality of spaces to be delivered through the porous membrane.

13. A fluidizing assembly comprising:
a bed having a curved shape, the bed having a gas injection opening and a drain aperture;
a porous membrane supported above the bed, the porous membrane having a plurality of channels and a drain opening, the plurality of channels having sizes that are between about 5 microns and about 20 microns and comprising a density of about 10 and about 50 percent of a material forming the porous membrane;
a pump to deliver a gas into a gap beneath the porous membrane with sufficient velocity to cause the gas to permeate through the plurality of channels and fluidize particulate material provided on the porous membrane; and
a drain member having a first portion provided on the bed at the drain aperture and a second portion provided on the porous membrane at the drain opening.

14. The system according to claim 13, wherein the plurality of channels have sizes that are about 10 microns and the porous membrane is formed with the plurality of channels comprising a density of about 30 percent of the material forming the porous membrane.

15. The system according to claim 13, further comprising:
a controllable feeder positioned beneath the bed to regulate flow of the particulate material through the drain member.
